(19) United States
(12) Patent Application Publication
(10) Pub. No.: US 2009/0145903 A1
(43) Pub. Date: Jun. 11, 2009

(54) FLUID FILL SYSTEM FOR AN AUTOMOTIVE VEHICLE

(76) Inventors: Michael W. Soltis, Livonia, MI (US); Furgan Zafar Shaikh, Troy, MI (US); Manoj Tummala, Troy, MI (US); Dean C. Armstrong, Keego Harbor, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/954,040

(22) Filed: Dec. 11, 2007

(51) Int. Cl. B60K 15/05; B65D 55/16

(52) U.S. Cl. 220/288; 220/375

(57) ABSTRACT

A fluid port for an automotive vehicle includes a neck, cap and tether. The cap is connected with the neck via the tether. The tether rotates with the cap as the cap is twisted relative to the neck. The cap may include a recessed portion to receive the tether. The cap may include a passageway for the tether to permit the cap to move relative to the tether.

### BACKGROUND

1. Field of the Invention

The invention relates to fluid fill systems for automotive vehicles.

2. Discussion

Selective catalytic reduction removes nitrogen oxides through a chemical reaction between exhaust gases, a reductant and a catalyst. A reductant, such as urea or ammonia, is added to the exhaust gas and absorbed onto a catalyst. The reductant reacts with NOₓ in the exhaust gas to form water vapor and nitrogen gas.

Urea may be used in conjunction with a catalytic converter of a diesel powered automotive vehicle to improve the emissions performance of the vehicle. In some applications, urea usage is approximately 2% of the diesel fuel usage. For example, for every 100 gallons of diesel fuel used by the vehicle, 2 gallons of urea are used by the vehicle.

Urea is stored on-board a vehicle in a urea reservoir. The urea reservoir may be filled by accessing a urea port located on the vehicle. Diesel fuel is also stored on-board the vehicle in a fuel tank. The fuel tank may be filled by accessing a diesel fuel port located on the vehicle.

The urea port and diesel fuel port may be located remote from each other. For example, the urea port may be located in an engine compartment of a vehicle and the diesel fuel port may be located on a side of the vehicle. The urea port and the diesel fuel port may also be located next to each other. For example, the urea port may be located adjacent to the diesel fuel port on a side of a vehicle.

Urea and diesel fuel ports typically include fluid caps that cover entrances of the ports. The caps retain the urea and diesel fuel in their respective lines and prevent foreign material from entering the urea reservoir and fuel tank. These caps may be connected with the vehicle and are usually installed and removed by turning the caps.

### SUMMARY

A fluid fill system for an automotive vehicle is configured to receive fluid from fluid dispensing devices. In some embodiments, the system includes a fluid filler neck having an end portion configured to receive a fluid dispensing device and a fluid filler cap having a recessed portion. In such embodiments, the system also includes a tether connecting the neck and the cap. The recessed portion is configured to receive at least a portion of the tether.

In other embodiments, the system includes a fluid filler neck having an end portion configured to receive a fluid dispensing device and a fluid filler cap. The system also includes a tether connecting the neck and the cap. The cap includes a passageway for the tether. The tether is movable within the passageway of the cap.

In still other embodiments, the system includes a first fluid filler neck having an end portion configured to receive a first fluid dispensing device and a fluid filler cap tethered to the first neck. The cap includes a passageway to receive an end of the tether. The end of the tether is movable within the passageway. The system also includes a second fluid filler neck disposed next to the first neck. The second neck has an end portion configured to receive a second fluid dispensing device.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a perspective view of a portion of an exemplary fuel fill system of an automotive vehicle according to certain aspects of the present invention.

FIG. 2 is an exploded assembly view of a portion of a port of the fuel fill system of FIG. 1.

FIG. 3 is a side view, partially in cross-section, of the neck, cap and tether of FIG. 2 in open position.

FIG. 4 is another side view, partially in cross-section, of the neck, cap and tether of FIG. 2 in closed position.

FIG. 5 is a perspective view of a portion of another exemplary fluid fill system according to certain aspects of the invention.

FIG. 6 is a side view, partially in cross-section, of the neck, cap and tether of FIG. 5 in closed position.

FIG. 7 is a side view, in cross-section, of a portion of yet another exemplary fluid fill system according to certain aspects of the invention.

### DETAILED DESCRIPTION

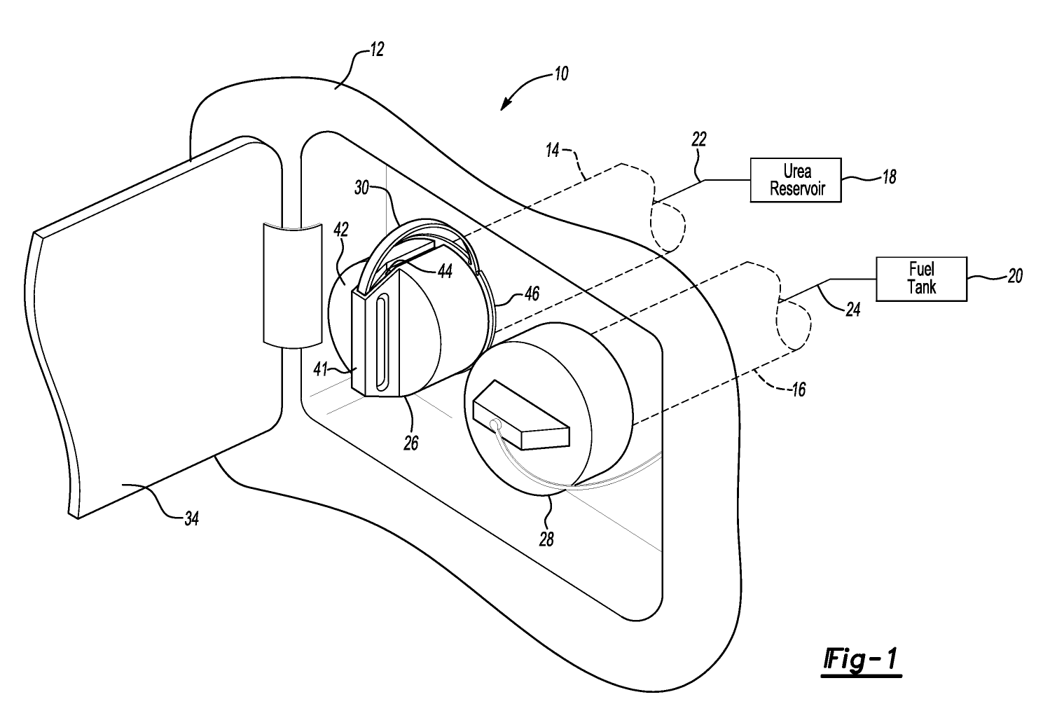

An exemplary fuel fill system 10 for an automotive vehicle 12 of FIG. 1 includes filler necks 14, 16 fluidly connected with tanks 18, 20 via pipes 22, 24. In the example of FIG. 1, the tank 18 is a urea reservoir and the tank 20 is a diesel fuel tank. In other examples, the tanks 18, 20 may be used for other fluids.

Caps 26, 28 cover the filler necks 14, 16 to retain the urea and diesel fuel in their respective lines and prevent foreign material from entering the filler necks 14, 16. The cap 26 is connected with the filler neck 14 via a tether 30. Fuel door 34 (shown in the open position) is hinged with the vehicle 12. The fuel door 34 may open and close to permit or prevent access to the fuel fill system 10.

The filler neck 14 is sized to receive urea from a urea dispensing device (not shown). The urea from the tank 18 is introduced into an exhaust gas stream of the vehicle 12. The urea reacts with NOₓ in the exhaust gas and is absorbed onto a catalyst of a catalytic converter (not shown). This reaction forms water vapor and nitrogen gas.

The neck 16 is sized to receive diesel fuel from a diesel fuel dispensing device (not shown). The diesel fuel from the tank 20 is introduced into a diesel engine (not shown) in order to create motive power to move the vehicle 12.

In other examples, filler necks may be sized as needed. For example, a first neck may be sized to receive gasoline and a second neck may be sized to receive some other type of fluid.

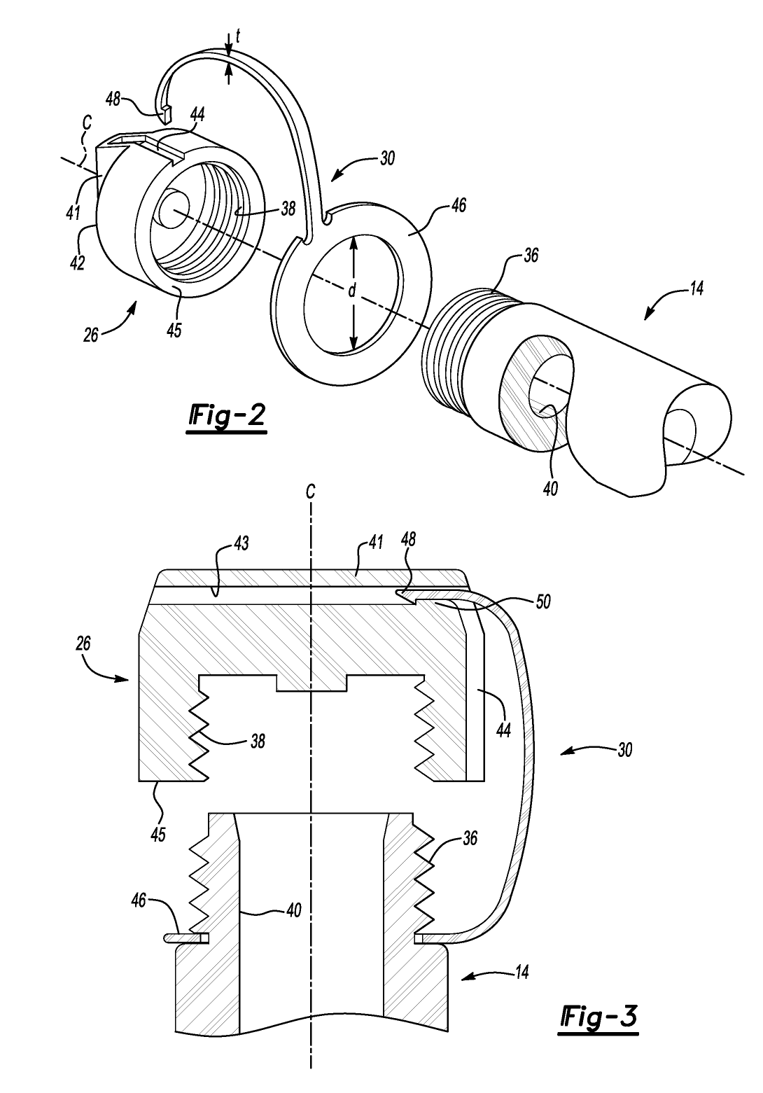

As may be seen in FIG. 2, the filler neck 14 is generally cylindrical and includes external threads 36 that engage internal threads 38 of the cap 26. The cap 26 is installed and removed from the filler neck 14 by twisting the cap 26 relative to the filler neck 14. This twisting action, depending on its direction, engages or disengages the internal threads 38 of the cap 26 with the external threads 36 of the filler neck 14. The filler neck 14 also includes a passageway 40. The passageway 40 extends along a cylindrical axis, C, from an end of the filler neck 14 connected with the pipe 22 (FIG. 1) to another end of the filler neck 14. The passageway 40 permits urea to flow from the urea dispensing device (not shown) to the pipe 22.

The cap 26 includes a projection 41 formed transverse to and extending away from a top 42 of the cap 26. The projection 41 permits a user to grip and twist the cap 26 during installation and removal. In other examples, the projection 41 may be formed as a cube or other shape that facilitates gripping and twisting by the user. The projection 41 includes a channel 43. The channel 43 runs end to end through the projection 41. As explained below, the channel 43 receives an end of the tether 30 and allows the tether 30 to move relative to the cap 26. The cap 26 also includes a slot 44 formed radially inward from a periphery of the cap 26. The slot 44 extends from a bottom 45 of the cap 26 to the projection 41 generally parallel to the cylindrical axis, C, in circumferential registration with the channel 43. As explained below, the slot 44 receives the tether 30.

The tether 30 includes a looped portion 46. The internal diameter, d, of the looped portion 46 is sized relative to the external threads 36 of the neck 14 such that, when assembled, the tether 30 rotates relative to the filler neck 14 as the cap 26 is twisted and the tether 30 resists being removed from the filler neck 14.

The tether 30 is made from a flexible material, e.g., plastic, having a thickness, t. During assembly, the looped portion 46 deforms as it is pushed over the external threads 36 of the filler neck 14. The tether also includes a bulbous end 48. During assembly, the bulbous end 48 is pushed into the channel 43.

The tether 30 is shown to form a curve between the looped portion 46 and the bulbous end 48. As explained below, this curve may bow away from the cap 26 when the cap 26 is assembled with the filler neck 14. As the cap 26 is turned, the cap 28 (FIG. 1), or other structure, may interfere with this portion of the tether 30 because of its proximity to the cap 26. Such interference may make it difficult to remove or install the cap 36. In other examples, the tether 30 may form an L-shape between the looped portion 46 and the bulbous end 48. Other configurations, such as a bellows configuration, are also possible.

As may be seen in FIG. 3, the channel 43 includes a step 50. During assembly, the bulbous end 48 of the tether 30 is pushed into the channel 43 past the step 50. The step 50 retains the bulbous end of the tether 30 by narrowing a portion of the channel 43. The step 50 thus forms an entrance to the channel 43. The tether 30 may move within the channel 43 but the bulbous end 48 of the tether may not move past the step 50. In the example of FIG. 3, the step 50 is located near an end of the projection 41. In other examples, the step 50 may be located in the middle of the projection 41 or elsewhere as desired.

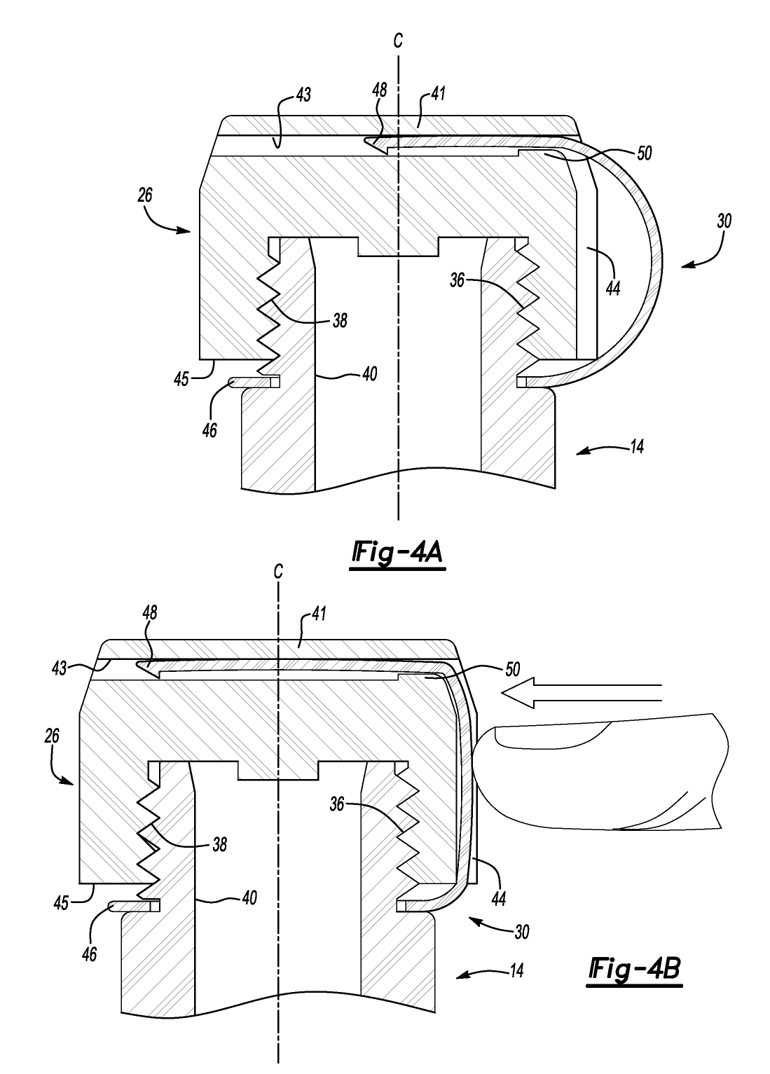

As may be seen in FIG. 4, the periphery of the cap 26 is at least radially coincident, relative to the cylindrical axis, C, with a periphery of the filler neck 14. When assembled, a portion of the tether 30 forms an arc (as shown in dotted line) relative to the cap 26. This arc may interfere with the installation and removal of the cap 26 because of its proximity to the cap 28 (FIG. 1), or other structure. The tether 30, however, may be pushed toward the cap 26 to reduce and/or eliminate this arc. For example, the tether 30 may be pushed into the slot 44 such that the thickness of the tether 30 is completely positioned within the periphery of the cap 26. In this example, the slot has depth at least equal to the thickness, t, of the tether 30. In other examples, the slot may have a depth less than the thickness, t, of the tether 30. As the tether 30 is pushed into the slot 44, the bulbous end 48 of the tether 30 moves within the channel 43. Minimizing or eliminating this arc facilitates ease of installation and removal of the cap 26.

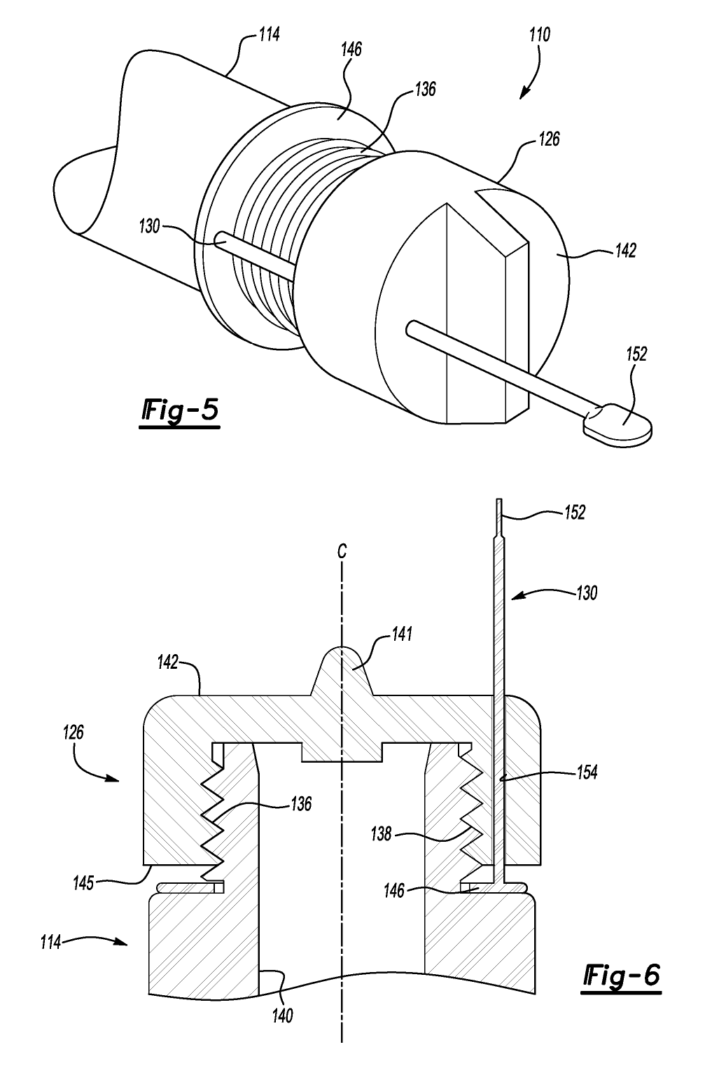

A portion of an exemplary fuel fill system 110 of FIG. 5 includes a filler neck 114, cap 126 and tether 130. Numbered elements differing by 100 have similar, although not necessarily identical, descriptions. The tether 130 projects away from a top 142 of the cap 126. A flattened end 152 of the tether 130 prevents the tether 130 from becoming disconnected with the cap 126. The flattened end 152 may be formed after the tether 130 is inserted into the cap 126.

As the cap 126 is installed or removed from the filler neck 114, the cap 126 moves relative to the tether 130. For example, as the cap 126 is removed from the filler neck 114, the cap 126 moves away from the filler neck 114. The looped portion 146 of the tether 130 rotates with the cap 126 and the cap 126 slides along the tether 130 toward the flattened end 152.

As may be seen in FIG. 6, a passageway 154 allows the cap 126 to move relative to the tether 130 as the cap 126 is installed or removed from the filler neck 114. The passageway 154 is formed within a side of the cap 126 and extends from a bottom 145 of the cap 126 to the top 142 of the cap 126. Because the tether 130 is confined within the periphery of the cap 126, another structure (not shown) in close proximity is not likely to interfere with the installation and removal of the cap 126.

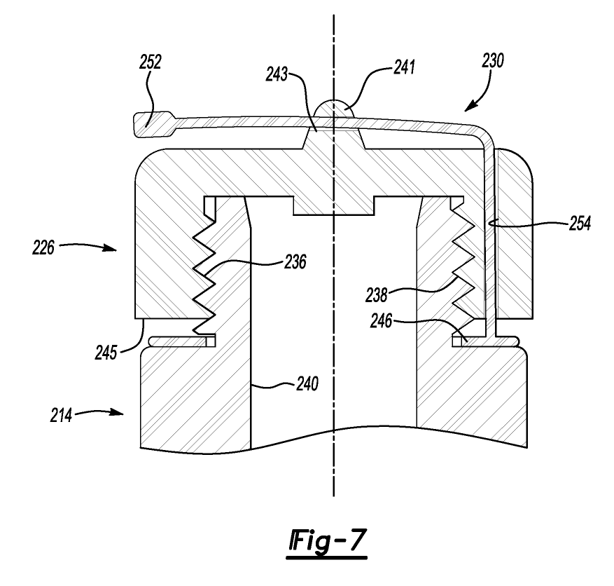

A portion of an exemplary fuel fill system 210 of FIG. 7 includes a cap 226 and tether 230. A projection 241 is formed transverse to and extends away from a top 242 of the cap 226. The projection 241 includes a channel 243. The length of the projection 241 is generally perpendicular to the length of the channel 243. The tether 230 passes through the channel 243.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fluid fill system for a fluid reservoir of an automotive vehicle, the fluid fill system being configured to receive fluid from a fluid dispensing device, the system comprising:
a fluid filler neck in fluid communication with the fluid reservoir, the neck having an end portion configured to receive the fluid dispensing device;
a fluid filler cap having a recessed portion; and
a tether connecting the neck and the cap, the recessed portion of the cap being configured to receive at least a portion of the tether.

2. The system of claim 1 wherein the tether has an end, wherein the cap includes a portion forming a passageway to receive the end of the tether and wherein the end of the tether is movable within the passageway of the cap.

3. The system of claim 1 wherein the tether has an end that loops around the neck.

4. The system of claim 3 wherein the end of the tether is carried rotatively free with respect to the neck.

5. The system of claim 2 wherein the cap includes a handle and wherein the passageway of the cap passes through the handle.

6. The system of claim 2 wherein the portion forming a passageway includes a step that reduces the cross-sectional area of the passageway.

7. The system of claim 6 wherein the end of the tether is configured to be pushed into the entrance to the passageway of the cap and to be retained by the entrance to the passageway of the cap.

8. The system of claim 1 wherein the cap has an outer periphery, wherein the recessed portion of the cap is formed extending radially inward from the outer periphery of the cap, wherein the tether has a thickness and wherein the recessed portion of the cap has a depth sufficient to receive at least a portion of the thickness of the tether.

9. A fluid fill system for a fluid reservoir of an automotive vehicle, the fluid fill system being configured to receive fluid from a fluid dispensing device, the system comprising:
a fluid filler neck in fluid communication with the fluid reservoir, the neck having an end portion configured to receive the fluid dispensing device;
a fluid filler cap; and
a tether connecting the neck and the cap, the cap including a portion forming a passageway for the tether and the tether being movable within the passageway of the cap.

10. The system of claim 9 wherein the cap further includes a recessed portion and wherein the recessed portion is configured to at least partially receive the tether.

11. The system of claim 9 wherein the tether has an end that loops around the neck.

12. The system of claim 11 wherein the end of the tether is configured to rotate around the neck if the cap is twisted relative to the neck.

13. The system of claim 9 wherein the cap includes a handle and wherein the passageway of the cap passes through the handle.

14. The system of claim 9 wherein the portion forming a passageway narrows to form an entrance to the passageway.

15. The system of claim 14 wherein the tether has an end configured to be pushed into the entrance to the passageway of the cap and to be retained by the entrance to the passageway of the cap.

16. The system of claim 9 wherein the cap is threadably engageable with the neck.

17. A fluid fill system for first and second fluid reservoirs of an automotive vehicle, the fluid fill system being configured to receive first and second fluids from first and second fluid dispensing devices, the system comprising:
a first fluid filler neck in fluid communication with the first fluid reservoir, the neck having an end portion configured to receive the first fluid dispensing device;
a fluid filler cap tethered to the first neck, the cap including a portion forming a passageway to receive an end of the tether and the end of the tether being movable within the passageway; and
a second fluid filler neck disposed next to the first neck, the second neck in fluid communication with the second fluid reservoir and the second neck having an end portion configured to receive the second fluid dispensing device.

18. The fluid fill system of claim 17 wherein the cap further includes a recessed portion configured to at least partially receive the tether.

19. The fluid fill system of claim 17 wherein the tether has another end that loops around the neck.

20. The system of claim 19 wherein the another end of the tether is configured to rotate around the neck if the cap is twisted relative to the first neck.

21. A fluid fill system for a fluid reservoir of an automotive vehicle, the fluid fill system being configured to receive fluid from a fluid dispensing device, the system comprising:
a fluid filler neck in fluid communication with the fluid reservoir, the neck having an end portion configured to receive the fluid dispensing device;
a fluid filler cap having an outer periphery, a recessed portion formed extending radially inward from the outer periphery and a portion forming a passageway; and
a tether having a first end, a second end and a thickness, the first end being configured to be received by the passageway of the cap and moveable within the passageway of the cap, the second end being configured to loop around the neck and be carried rotatively free with respect to the neck, and the recessed portion of the cap having a depth sufficient to receive at least a portion of the thickness of the tether.
